(19) United States
(12) Patent Application Publication
(10) Pub. No.: US 2012/0113133 A1
(43) Pub. Date: May 10, 2012

(54) SYSTEM, DEVICE, AND METHOD FOR MULTIPLYING MULTI-DIMENSIONAL DATA ARRAYS

(76) Inventor: Shai SHPIGELBLAT, Ranaana (IL)

(21) Appl. No.: 12/939,278

(22) Filed: Nov. 4, 2010

(51) Int. Cl. G09G 5/00; G06F 7/52

(52) U.S. Cl. 345/619; 708/607

(57) ABSTRACT

A system, processor, and method for multiplying multi-dimensional data, for example, matrices, stored in vector memories. Each data element in a vector memory representing a sequential single element in a row of a left operand data array may be multiplied with a respective vector in a vector memory representing a sequential row in the right operand data array. The memory element representing the left operand element may be multiplied with the memory vector representing the right operand row that is in the same sequential order. A plurality of vectors of product elements may be generated by the multiplying. A single product element from each of the plurality of vectors of product elements may be added to a sum of product elements to generate each respective element in the same sequential order in a row of a product data array to generate a vector of a complete row of elements of the product data array.

### BACKGROUND OF THE INVENTION

The present invention relates to processing multi-dimensional data and more particularly to a system and method for multiplying multi-dimensional data arrays, for example, two (2) two-dimensional (2D) matrices.

Multi-dimensional data arrays may include an array of data elements spanning multiple rows and columns, for example, in a 2D matrix or grid. In some computer architectures, for example, using a digital signal processing (DSP) core, processors manipulate data by storing the data elements from each data array in internal vector memor(ies), for example, in the order that they are sequentially listed in each row of the data array.

Certain operations, such as addition, compose sequential elements in rows of the data array and are thus compatible with the row structure of the vector memories. However, other operations, such as multiplication, compose elements from rows of a left operand data array with columns of a right operand data array. Since vector memories do not store columns of elements, the composition of row and column elements is not compatible with the exclusively row structure of vector memories.

Current solutions for multiplying data arrays include rearranging elements in vector memories from a row structure to a column structure. However, such solutions add extra processing steps for rearranging elements and alter the native row structure of vector memories. Although a column data structure may be useful for multiplication, other operations, such as addition, rely on the native row structure of vector memories and, without additional instructions, will be unable to operate on such non-native memory structures. Another solution, which maintains the native row structure of the vector memories, composes the row and column data array products used for multiplication simply by multiplying every combination of row elements in the vector memories, extracting the necessary products and discarding the rest. This brute-force approach wastes a significant amount of computational resources.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Specific embodiments of the present invention will be described with reference to the following drawings, wherein:

FIG. 1 is a schematic illustration of a system in accordance with embodiments of the invention;

FIG. 2 shows the composition of elements for multiplying multi-dimensional data arrays helpful in understanding embodiments of the invention;

FIG. 3 is a schematic illustration of an exemplary mechanism for multiplying multi-dimensional data arrays in accordance with embodiments of the invention;

FIG. 4 is a schematic illustration of a detailed view of the elements of the mechanism for multiplying multi-dimensional data arrays of FIG. 3 in accordance with embodiments of the invention;

FIG. 5 is a schematic illustration of data structures of the multi-dimensional data arrays of FIG. 4 in accordance with embodiments of the invention; and

FIG. 6 is a flowchart of a method in accordance with embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In some systems, when multi-dimensional data is queued for processing, a processor may transfer data elements from a multi-dimensional data structure, which may be relatively difficult to process, to a one-dimensional string of data elements, which may be relatively simple to process. The one-dimensional string of data elements may be stored in an internal processor memory for direct and efficient processor access. In one embodiment, the internal memory may be a vector memory. The data elements may be ordered as a string of data elements in each vector memory, for example, in the sequential order in which the elements were ordered in each row in the data array, of one or more rows of the data array, for example, one row after another, in the sequential order in which the rows are ordered in the data array. In an example of a (2×2) data array,

$$A = \begin{matrix}{a}_{00} & {a}_{01} \\ {a}_{10} & {a}_{11}\end{matrix}$$

the data elements of the data array may be stored as a first memory vector, a=(a₀₀, a₀₁, a₁₀, a₁₁) at a first memory address. Similarly, the data elements of another (2×2) data array,

$$B = \begin{matrix}{b}_{00} & {b}_{01} \\ {b}_{10} & {b}_{11}\end{matrix}$$

may be stored as a second memory vector, b=(b₀₀, b₀₁, b₁₀, b₁₁) at a second memory address.

The product of these the (2×2) data arrays, A and B above, generates a product data array, AB, which may be for example:

| | |
|---|---|
| a₀₀ × b₀₀ + a₀₁ × b₁₀ | a₀₀ × b₀₁ + a₀₁ × b₁₁ |
| a₁₀ × b₀₀ + a₁₁ × b₁₀ | a₁₀ × b₀₁ + a₁₁ × b₁₁ |

The data elements of the (2×2) product data array may be stored as a third memory vector, ab=(a₀₀×b₀₀+a₀₁×b₁₀, a₀₀×b₀₁+a₀₁×b₁₁, a₁₀×b₀₀+a₁₁×b₁₀, a₁₀×b₀₁+a₁₁×b₁₁) at a third memory address.

In general, for a (m×n) left operand data array, A, with a (n×p) right operand data array, B, the (ij^{th}) element of the resultant product data array, AB, may be the sum of the products of sequential pairs of element with the same index in the i^{th} row of data array, A, and the j^{th} column of data array, B. That is, every row of data element in the data array A may multiply every column of data element of the data array B for all combinations of rows and columns in data arrays A and B. The (ij^{th}) element of the product data array, AB, may be, for example:

$${( AB )}_{i , j} = {\sum }_{r = 1}^{n} {A}_{i , r} {B}_{r , j} , \qquad ( 1 )$$

for each pair of rows, i, and columns, j, with 1≦I≦m and 1≦j≦p, where i, j, m, n, p, and r are positive integers greater than (1).

Multiplying and storing the elements of the product data array AB may be a difficult task since the native structure of the vector memories (storing rows of elements) in which the elements are stored is not compatible with the composition of elements in equation (1) (from both rows and columns). Since all the left operand elements, A_{i,r}, are stored in one memory vector, a, and all the right operand elements, B_{r,j}, are stored in another memory vector, b, these elements may be processed together as rows. A standard vector multiplication of the vectors a and b generates products of data elements with the same (ij^{th}) index, for example, (a₀₀b₀₀, a₀₁b₀₁, a₁₀b₁₀, a₁₁b₁₁). However, vector multiplication is different from matrix multiplication. Only some of these vector products (for example, those with the same i^{th} and j^{th} indices) may be used for multiplying data arrays A and B, while the remainder of these products are typically unused and may be discarded. In the example of the (2×2) data arrays above, (2) of the vector products are used to multiply the data arrays and (2) vector products are unused and discarded. The greater the size of the data arrays multiplied, the larger the number of data elements discarded and the larger the amount of wasted computational effort. Furthermore, the vector products used to multiply data arrays only constitute a subset of the products necessary for multiplying these data arrays. In fact, each of the usable vector products constitutes just one of a plurality of products summed in a linear combination for one of the diagonal (ii^{th}) elements of the product data array AB. The remainder of the products necessary for multiplying the data arrays are left unaccounted for.

The additional products needed to generate the product data array, AB, may include every combination of elements (A_{i,r}) and (Bᵣⱼ) in vector a and b with different indices, i≠j, for r=1, . . . , n. To generate these products, processors may multiply elements (A_{i,r}) in a single row (i), stored in the same vector memory, with elements (Bᵣⱼ) in a single column (j), for example, each element stored in a different vector memory, for r=1, . . . , n. Since a processor typically manipulates all elements of a vector memory together, the native vector memory structure may preclude “intra” vector memory operations, which apply different operations to different elements (A_{i,r}) within the same vector memory, for example, multiplying by elements (Bᵣⱼ) in different vector memories.

To independently manipulate each element (A_{i,r}) while maintaining the native vector memory structure, some conventional systems use a brute-force approach, for example, multiplying every combination of row vector memories a and b, extracting the usable products and discarding the rest. For example, to generate the product of row elements a₀₀ and a₀₁ in vector memory, a, with column elements b₀₀ and b₁₀, respectively, since elements b₀₀ and b₁₀ are stored in different vector memories, the conventional processor may multiply the elements of vector memory a twice, once by the vector memory storing element b₀₀ and again with the vector memory storing element b₁₀. The processor may then extract the products, a₀₀b₀₀ and a₀₁b₁₀, which are used to generate the product data array AB, and may discard the remaining products, a₀₀b₀₁ and a₀₁b₀₀, which are not. This technique executes unnecessary operations on data elements for which the multiplication operations are not intended and also requires separate operations to multiply elements in a row of A by values in a column (different rows) of B.

In another conventional system, in order to individually manipulate each of the data elements for every product of data elements, a processor may alter the native data structure of the vector memories. In one such system, a processor may store each data element in a separate register. In the example of the (2×2) data arrays A and B, the (2) elements in each of the vector memories a and b are separated into a total of (4) vector memories. However, the number of vector memories increases as the number of data elements in both data arrays increases, for example, requiring a total of (mn)+(np) vector memories for an (m×n) data array, A, and an (n×p) data array, B. This technique uses a large number of vector memories and a correspondingly large number of address resources and extra computational cycles for separately storing the data elements. In another system, a processor may rearrange the elements to store each column of the right operand data array B as a row of consecutive elements in a single vector memory. In addition to the extra computational cycles for rearranging the data elements, altering the native data structure may render the data elements unusable in other operations (for example, adding data arrays), which rely on the native data structures.

Embodiments of the invention provide a system, method, and processor, that multiply multi-dimensional data arrays using a reduced number of multiplication operations and computational cycles (for example, using a single computational cycle to generate each row of the product data array), without the drawbacks of conventional systems.

Embodiments of the invention exploit the inherent relationship between the native data structure of data arrays stored in vector memories and the organization of elements composed in matrix multiplication to operate efficient multipliers on the data arrays. Each of the p horizontally sequential data elements in each row of the product data array, AB, of an (m×n) data array, A, with an (n×p) data array, B, may be a linear combination (or sum of) n products (A_{i,r}B_{r,j} for r=1, . . . , n). Although the linear combinations of the product data array AB include many combinations of terms, a common pattern is observed and exploited for efficient multiplication. That is, the (r^{th}) term (A_{i,r}B_{r,j}) of each of the (n) products (r=1, . . . , n) of the linear combinations in each row (i) of the product data array AB is composed of a value (the left operand value, A_{i,r}) that is the same for all elements in the row. In addition, the (r^{th}) term (A_{i,r}B_{r,j}) is composed of another value (the right operand value, B_{i,r}) that is different for each of the (n) linear combinations in the row of the product data array AB. The variance of this right operand value, however, also follows a pattern. The different values (the right operand value, B_{r,j}) used for the (r^{th}) terms of each linear combination of each sequential data element in the same row (i) of the product data array is composed of sequential data element in the corresponding (r^{th}) row of the right operand data array, B.

Accordingly, in some embodiments of the invention, a processor may compute each sequential (r^{th}) term (A_{i,r}B_{r,j}) in each linear combination for the (p) elements in a row (i) of the product data array, AB, using the products of a single (r^{th}) value (the left operand, A_{i,r}) in the same row of the left operand data array, A, and a corresponding plurality of sequential data element (Bᵣ) in the (r^{th}) row of the right operand data array, B. Since data elements in each row of the right operand data array, B, are stored in consecutive and sequential order in a single vector memory, the processor may generate the entire set of the (r^{th}) terms (A_{i,r}B_{r,j}), in each row (i) of the product data array, AB, in a single product operation, for example, multiplying the single (r^{th}) value (left operand value, A_{i,r}) and the vector memory storing the (p) sequential data elements (right operand elements Bᵣ) in the (r^{th}) row of the right operand data array, B, for each respective index (r=1, . . . , n).

For each (r^{th}) product of the single value (A_{i,r}) with the row vector (Bᵣ) of (p) sequential data elements, the processor may generate (p) resulting terms (A_{i,r}B_{r,q}). The processor may add each of the (p) resulting terms sequentially (for example, in the order in which the right operand value (B_{r,q}) is arranged in the right operand data array, B, or stored in the vector memory) into the corresponding sequential (p^{th}) one of the linear combinations for the (p) consecutive data elements in the corresponding (i^{th}) row of the product data array. Each sum of the corresponding (p^{th}) one of each of the (r^{th}) products for each r=1, . . . , n may generate each element in the row (i) of the product data array AB. The process may be repeated for each row (i=1, . . . , m) of the left operand matrix A to generate each (m^{th}) row of the product data array AB.

In total, to generate the entire product data array, a processor may compose the products of each (r^{th}) value (A_{i,r}) of (n) consecutive values in each (i^{th}) row of the (m×n) left operand data array, A, with a set of (p) sequential values (B_{r,q}) in the (r^{th}) row of the right operand data array, B, for all (n) rows (r=1, n) of the right operand data array, B, respectively. The processor may use (n) computations to compute the (p) data elements in each row of the (m×p) product data array and (mn) computations to compute all (mp) data elements in the entire product data array, AB.

In some embodiments of the invention, a multiplication module or multiplication dedicated instructions may assign each of the (n) computations to a separate one of (n) parallel processors or multiply/accumulate units to execute (n) computation in parallel. Each of the (n) multiply/accumulate units may both multiply each of (n) products and add the product result to the corresponding linear combination in a single cycle. When the (n) computations are executed in parallel by (n) multiply/accumulate units, each full row of the (m×p) product data array may be generated in a single computational cycle and the entire data array of (m) rows may be generated in (m) computational cycles.

In contrast, some conventional mechanisms, which divide the elements into separate memories typically use (pn) computations to compute the (p) data elements in each row of the product data array and (mpn) computations to compute all (mp) data elements in the product data array (for example, compared to the (n) and (mn) computations, respectively, used according to embodiments of the invention). When using a single multiply/accumulate unit (one multiplication per cycle), these conventional processors may use a total of (pn) and (mpn) computational cycles to generate each row and the product array, respectively. When using (n) parallel multiply/accumulate units, conventional processors may only reduce the computational cycles up to a total of (p) and (mp) computational cycles to generate each row and data array, respectively (for example, compared to the (1) and (m) computations used according to embodiments of the invention). Since conventional systems do not include dedicated instructions or multiplication modules that automatically activate (n) parallel multiply/accumulate units, extra instructions may be required in conventional systems to execute parallel processing, further slowing down computations as compared to embodiments of the invention, in which parallel processing is automatically triggered by the multiplication-dedicated instructions. Furthermore, conventional systems operating on individual elements of the left and right operand data arrays may use additional computations to separate each element into an individually addressable memory unit. Accordingly, embodiments of the invention may provide at least a (p)-fold (and up to an (np)-fold or greater) decrease in the number of computations and computational cycles used to multiply data arrays as compared with conventional mechanisms.

Furthermore, in contrast with other conventional systems which multiply every combination of left and right operand rows, generating many unusable and wasted products, embodiments of the invention generate only usable products, wasting no computational effort and discarding no extraneous products.

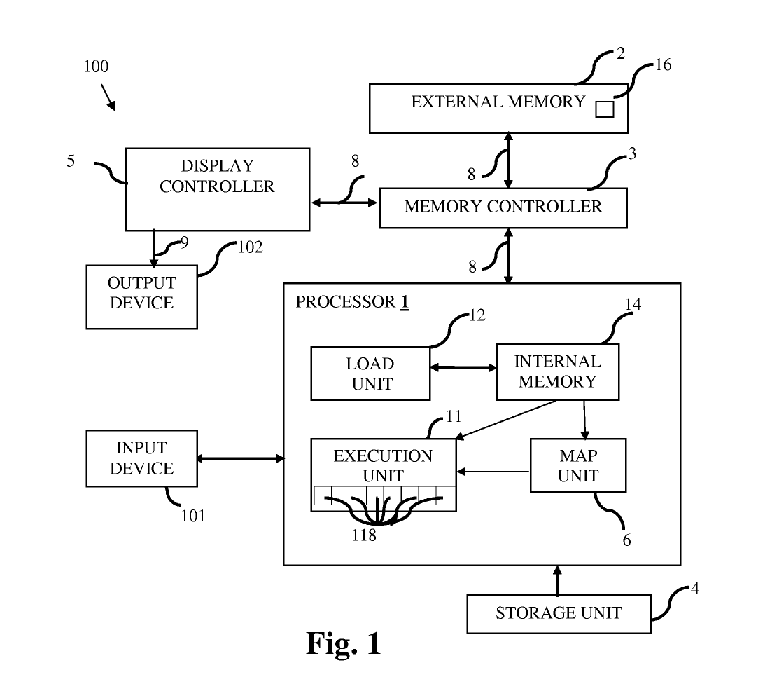

Reference is made to FIG. 1, which is schematic illustration of an exemplary device in accordance with embodiments of the invention.

Device 100 may include a computer device, video or image capture or playback device, cellular device, or any other digital device such as a cellular telephone, personal digital assistant (PDA), video game console, etc. Device 100 may include any device capable of executing a series of instructions to record, save, store, process, edit, display, project, receive, transfer, or otherwise use or manipulate multi-dimensional data, such as, video, image, or audio data. Device 100 may include an input device 101. When device 100 includes recording capabilities, input device 101 may include an imaging device such as a camcorder including an imager, one or more lens(es), prisms, or minors, etc. to capture images of physical objects via the reflection of light waves therefrom and/or an audio recording device including an audio recorder, a microphone, etc., to record the projection of sound waves thereto.

When device 100 includes image processing capabilities, input device 101 may include a pointing device, click-wheel or mouse, keys, touch screen, recorder/microphone using voice recognition, other input components for a user to control, modify, or select from video or image processing operations. Device 100 may include an output device 102 (for example, a monitor, projector, screen, printer, speakers, or display) for displaying multi-dimensional data such as video, image or audio data on a user interface according to a sequence of instructions executed by processor 1.

An exemplary device 100 may include a processor 1. Processor 1 may include a central processing unit (CPU), a digital signal processor (DSP), a microprocessor, a controller, a chip, a microchip, a field-programmable gate array (FPGA), an application-specific integrated circuit (ASIC) or any other integrated circuit (IC), or any other suitable multi-purpose or specific processor or controller.

Device 100 may include an external memory unit 2 and a memory controller 3. Memory controller 3 may control the transfer of data into and out of processor 1, external memory unit 2, and output device 102, for example via one or more data buses 8. Device 100 may include a display controller 5 to control the transfer of data displayed on output device 102 for example via one or more data buses 9.

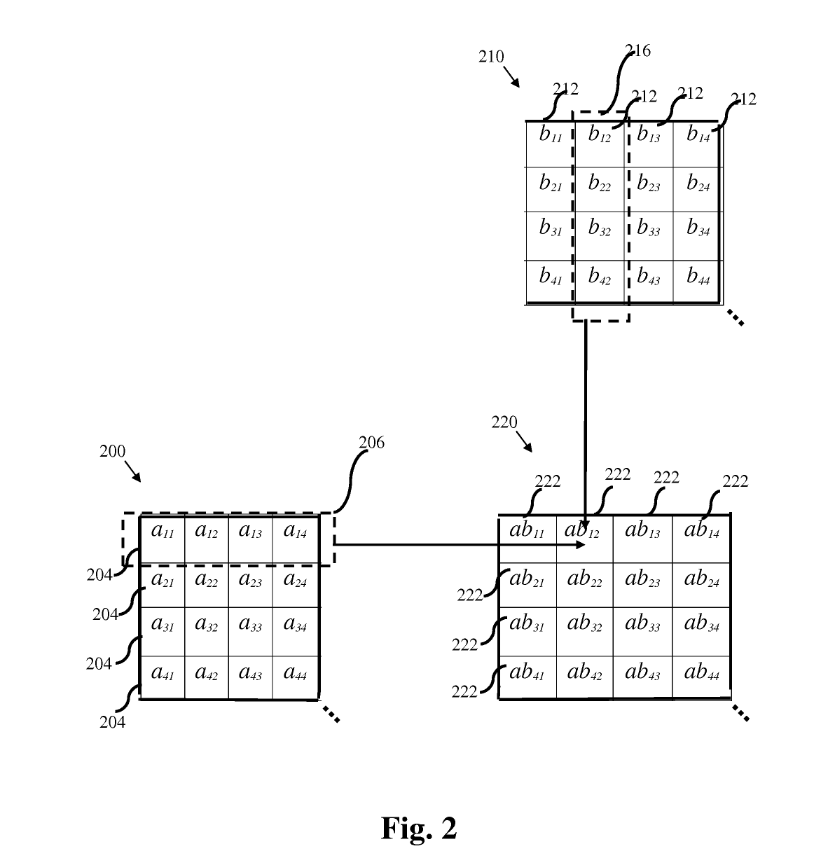

Device 100 may include a storage unit 4. Storage unit 4 may store multi-dimensional data in a compressed form, while external memory unit 2 may store multi-dimensional data in an uncompressed form; however, either compressed or uncompressed data may be stored in either memory unit and other arrangements for storing data in a memory or memories may be used. For multi-dimensional video or image data, each uncompressed data element may have a value uniquely associated with a single pixel in an image or video frame, while each compressed data element may represent a variation or change between the value(s) of pixels within a frame or between consecutive frames in a video stream or moving image. When used herein, unless stated otherwise, a data element generally refers to an uncompressed data element, for example, relating to a single pixel value or pixel component value (for example, a YUV or RGB value) in a single image frame, and not a compressed data element, for example, relating to a change between values for a pixel in consecutive image frames. Uncompressed data for an array of pixels may be represented in a corresponding multi-dimensional data array or memory structure (for example, as in FIGS. 2-5), while compressed data may be represented as a data stream or one-dimensional (1D) data array (not shown).

Internal memory unit 14 may be a memory unit directly accessible to or internal to (physically attached or stored within) processor 1. Internal memory unit 14 may be a short-term memory unit, external memory unit 2 may be a long-term or short-term memory unit, and storage unit 4 may be a long-term memory unit; however, any of these memories may be long-term or short-term memory units. Storage unit 4 may include one or more external drivers, such as, for example, a disk or tape drive or a memory in an external device such as the video, audio, and/or image recorder. Internal memory unit 14, external memory unit 2, and storage unit 4 may include, for example, random access memory (RAM), dynamic RAM (DRAM), flash memory, cache memory, volatile memory, non-volatile memory or other suitable memory units or storage units. Internal memory unit 14, external memory unit 2, and storage unit 4 may be implemented as separate (for example, “off-chip”) or integrated (for example, “on-chip”) memory units. In some embodiments in which there is a multi-level memory or a memory hierarchy, storage unit 4 and external memory unit 2 may be off-chip and internal memory unit 14 may be on-chip. For example, internal memory unit 14 may include a tightly-coupled memory (TCM), a buffer, or a cache, such as, an L-1 cache or an L-2 cache. An L-1 cache may be relatively more integrated with processor 1 than an L-2 cache and may run at the processor clock rate whereas an L-2 cache may be relatively less integrated with processor 1 than the L-1 cache and may run at a different rate than the processor clock rate. In one embodiment, processor 1 may use a direct memory access (DMA) unit to read, write, and/or transfer data to and from memory units, such as external memory unit 2, internal memory unit 14, and/or storage unit 4. Other or additional memory architectures may be used.

Processor 1 may include a load/store unit 12, a mapping unit 6, and an execution unit 11. Processor 1 may request, retrieve, and process data from external memory unit 2, internal memory unit 14, and/or storage unit 4 and may control, in general, the pipeline flow of operations or instructions executed on the data.

Processor 1 may receive an instruction, for example, from a program memory (for example, in external memory unit 2 and/or storage unit 4) to multiply two or more multi-dimensional data arrays. In one example, the instruction may filter or edit an image by multiplying a multi-dimensional right operand data array representing the pixel values of a region of the image by a multi-dimensional left operand data array representing the image filter. Instructions may identify the data elements or arrays multiplied, for example, by the memory address in which the data elements are stored.

In each computational cycle, load/store unit 12 may retrieve a set or “burst” of data elements from each data array and store the elements, for example, in the order in which they are sequentially listed in each single row of the data array, one row after another in the order of the rows in the data array. Processor 1 may include a plurality of individually addressable memory units 16 for storing the multi-dimensional data. Individually addressable memory unit 16 (for example, vector registers) may be internal to processor 1 and either internal/integrated with internal processor 14 or external/separate from internal processor 14. Processor 1 may transfer the data elements to a memory relatively more internal or accessible to the processor 1, for example, from external memory unit 2 to an internal memory unit 14 (such as a TCM), or from a first internal memory unit 14 to vector register (individually addressable memory units 16) within the internal memory unit 14. When using vector registers, processor 1 transfers data array elements to a plurality of vector registers, each vector register storing a single row of the elements or to a single vector register storing a plurality of rows of the elements in a sequence, one row after another.

Once the data elements from the multi-dimensional data arrays are stored in their respective individually addressable memory unit(s) 16, processor 1 may command one or more multiply/accumulate units 118 to multiply the data array elements by manipulating their individually addressable memory unit(s) 16.

Reference is made to FIG. 2, shows the composition of elements for multiplying multi-dimensional data arrays helpful in understanding embodiments of the invention. A left operand data array 200 having elements (aᵢⱼ) and a right operand data array 210 having elements (bᵢⱼ) may be multiplied to generate a product data array 220. According to equation (1), elements in rows 204 of product data array 220 may be composed with elements in columns 212 of right operand data array 210. In some embodiment, each (ij^{th}) element 222 of product data array 220 may be the sum of the products of sequential pairs of element with the same index, r, in the (i^{th}) row 206 of left operand data array 200 and the (j^{th}) column 216 of right operand data array 210.

Elements of the data arrays 200 and 210 may be stored in memory unit(s) (e.g., individually addressable memory unit(s) 16 of FIG. 1) such as vector register memories. Although the vector memories may store rows 204 of left operand data array 200, they do not typically store columns of right operand data array 210.

Embodiments of the invention provide a solution to compose elements of rows 206 of left operand data array 200 with columns 216 of right operand data array 210 multiplication mechanism using the native storage structure of vector memories and without generating extra or wasteful products.

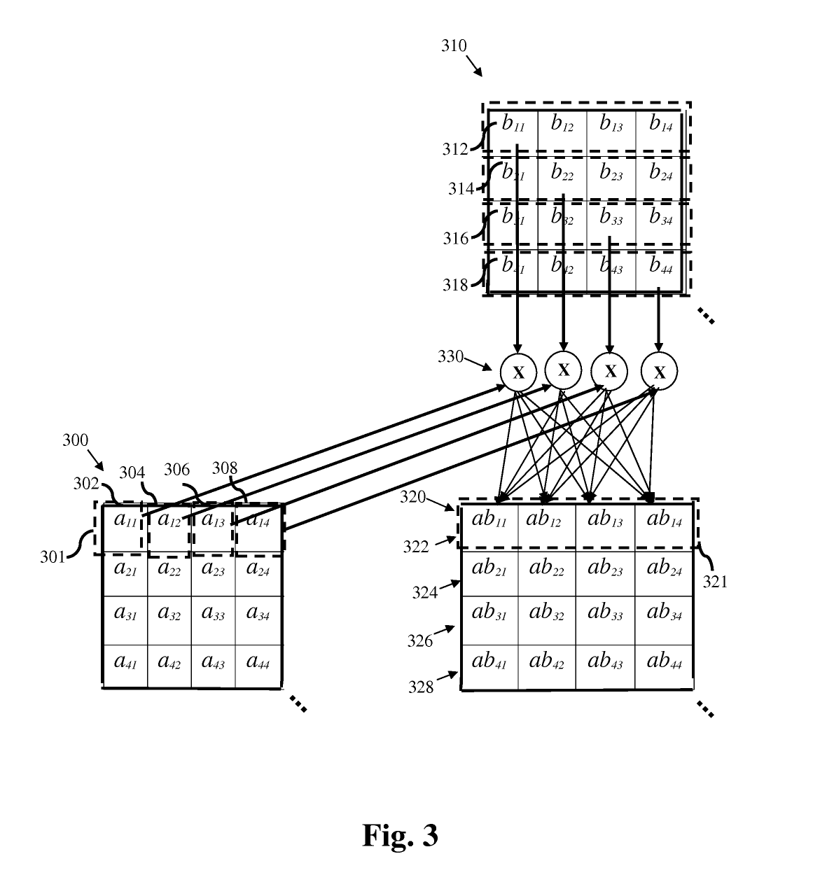

Reference is made to FIG. 3, which is schematic illustration of an exemplary mechanism for multiplying multi-dimensional data arrays in accordance with embodiments of the invention. One or more multiply/accumulate units 330 (e.g., multiply/accumulate units 118 of FIG. 1) may multiply a (m×n) left operand data array 300 having elements (aᵢⱼ) and a (n×p) right operand data array 310 having elements (bᵢⱼ) to generate a (m×p) product data array 320 having elements (abᵢⱼ)=(aᵢᵣbᵣⱼ), for r=1, . . . , n, according to embodiments of the invention. That is, the product data array 320 may have (m) rows 321 each having (p) elements, where each of the (p) elements is a linear combination of elements from rows of left operand data array 300 composed with elements from columns of right operand data array 310. Values m, n, and p may be any positive integers greater than (1) and r=1, . . . , n.

To generate the elements to compose each (i^{th}) row 321 of elements of the product data array 320, multiply/accumulate units 330 may multiply each single (r^{th}) element of the corresponding (i^{th}) row 301 of the left operand data array 300 by the (p) elements in the (r^{th}) row of the right operand data array 310 to generate (p) products, and may repeat this multiplication for each index r, where r=1, . . . , n. For example, the first element 302 of the left operand data array 300 may be composed with the first row 312 of the right operand data array 310; the second element 304 of the left operand data array 300 may be composed with the second row 314 of the right operand data array 310; and so on for each of the (n) elements in row 301 and (n) rows 312-318, respectively.

For each of the (r^{th}) products, multiply/accumulate units 330 may add each of the (p) resulting terms to be the (r^{th}) term of a different one of the (p) linear combinations of the (p) elements in the row 321 of the product data array 320. For example, the (p) products generated by multiplying the first element 302 of the left operand data array 300 with the first row 312 of the right operand data array 310 may generate the first terms in the linear combinations of all the elements 322 in the first row of the product data array 320. Similarly, the (p) products generated by multiplying the second element 304 of the left operand data array 300 with the second row 314 of the right operand data array 310 may generate the second terms in the linear combinations of all the elements 322 in the first row of the product data array 320.

Each one of the (p) products (generated by multiplying an element of left operand data array 300 by a row of right operand data array 310) has the same left operand element, aᵢᵣ, from left operand data array 300, but a different right operand element, bᵣⱼ, from right operand data array 310. In some embodiments, multiply/accumulate units 330 may add the single one of the (p) products to the linear combination for the single element 322 of the product data array 320 that is in the same column in the product data array 320 as the right operand element multiplied in the product is ordered in the right operand data array 310. In this way, each element of the product data array 320 is composed of elements from the right operand data array 310 which are aligned in the same (p^{th}) column and elements from the left operand data array 300 which are aligned in the same (i^{th}) row, for example, as described according to equation (1).

Multiply/accumulate units 330 may compute (n) products of each sequential element 302-308 of left operand data array 300 and each sequential row 312-318 of right operand data array 310, respectively, until all the (n) products in each of the (p) linear combinations of the (p) elements 322 of a row 321 of product data array 320 are generated and added together for each (i^{th}) row. These computations are repeated for each (i^{th}) row 3011=l, m of the left operand data array 300 to generate the (i^{th}) row 321 of the product data array 320.

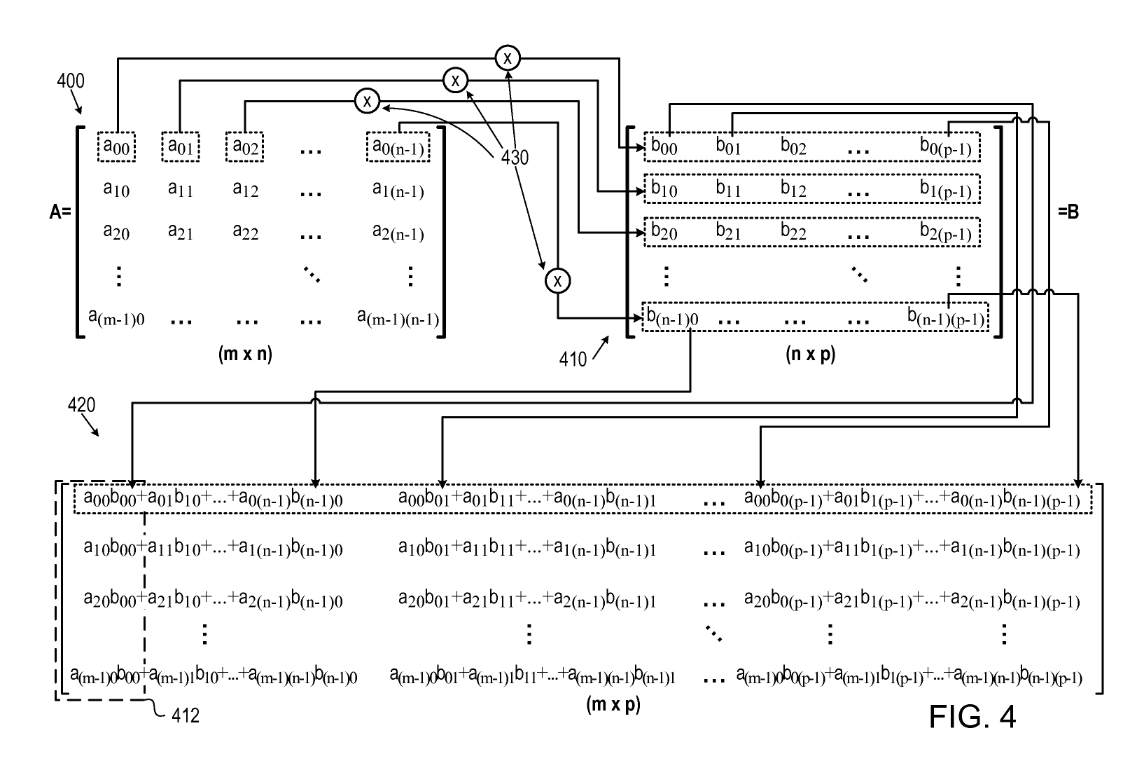

Reference is made to FIG. 4, which is schematic illustration of a detailed view of the elements of the mechanism for multiplying multi-dimensional data arrays of FIG. 3 in accordance with embodiments of the invention.

A (m×n) left operand data array 400 having elements (aᵢⱼ) and a (n×p) right operand data array 410 having elements (bᵢⱼ) may be multiplied to generate a (m×p) product data array 420 having elements (abᵢⱼ)=(aᵢᵣbᵣⱼ), for r=1, . . . , n, according to embodiments of the invention described in reference to FIG. 3.

Multiply/accumulate units 430 may multiply single elements of the left operand data array 400 by multiple elements in row vectors of the right operand data array 410 to generate a plurality of vector products. From each of the vector products, multiply/accumulate units 430 may group and add the terms in the same sequence coordinates to generate the element in a row of the product matrix 420 with the same row coordinate. The process may be repeated for each row of the left operand data array 400 (with all rows of the right operand data array 410) to generate each row of the product data array 420.

In some embodiments, multiply/accumulate units 430 (e.g., multiply/accumulate units 118 of FIG. 1) may multiply the single (r^{th}) sequential element in the (i^{th}) row of the left operand data array 400, a_{i,r}, with the plurality (p) elements, bᵣ₀, . . . , bᵣ₍ₚ₋₁₎, in the (r^{th}) sequential row of the right operand data array 410 to generate (p) products, a_{i,r}bᵣ₀, . . . , a_{i,r}bᵣ₍ₚ₋₁₎. These (p) products, a_{i,r}bᵣ₀, . . . , a_{i,r}bᵣ₍ₚ₋₁₎, may be divided or split in sequential order among the (p) elements in the (i^{th}) row of the product data array 420. Multiply/accumulate units 430 may add the single one of the (p) products to the linear combination for the element of the product data array 420 in the same column as the right operand element in right operand data array 410. Thus, elements in the right operand data array 410 and product data array 420 are vertically aligned. Furthermore, since elements of the (i^{th}) row of the product data array 420 are composed of elements of the same (i^{th}) row of the left operand data array 400, elements in the left operand data array 400 and product data array 420 are horizontally aligned. This alignment composes elements of the product data array, for example, as shown in FIG. 2.

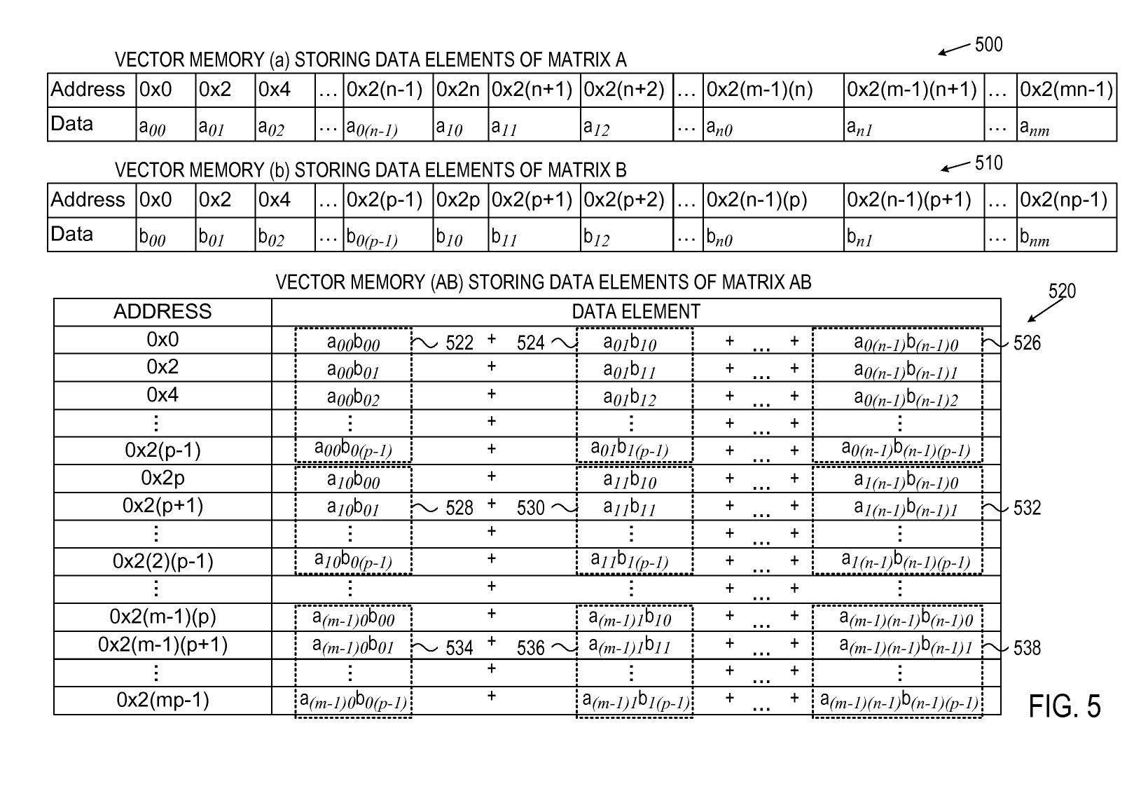

Reference is made to FIG. 5, which is schematic illustration of data structures of the multi-dimensional data arrays of FIG. 4 in accordance with embodiments of the invention.

A vector memory 500 may store the (mn) elements (aᵢⱼ) of a (m×n) left operand data array (for example, left operand data array 400 of FIG. 4), a vector memory 510 may store the (np) elements (bᵢⱼ) of a (n×p) right operand data array (for example, right operand data array 410 of FIG. 4), and a vector memory 520 may store the (mp) elements (abᵢⱼ)=(aᵢⱼbᵣⱼ), for r=1, . . . , n, of an (m×p) product data array (for example, product data array 420 of FIG. 4). Each vector memory 500, 510, and 520 may store elements from their corresponding data array (for example, data arrays 400, 410, and 420, respectively, of FIG. 4) in sequential order, for example, as they are sequentially listed in each row. Each vector memory 500, 510, and 520, may store elements from a single row of the corresponding data array or, alternatively, from multiple rows of the data array (for example, storing the entire data array). The rows may be listed in the same order as in the data array, where elements of a preceding row of a data array (for example, having a smaller row index) may precede elements of a subsequent row in the vector memory. Accordingly, rows which are vertically stacked from top to bottom in the data arrays may be listed sequentially in the corresponding respective vector memories.

A processor (e.g., processor 1 of FIG. 1) may compose the left and right operand elements, for example, stored in their native row storage structures in vector memories 500 and 510, in such a way so that all the product terms generated are added (and no extra products need be added) to generate the product data array stored in vector memory 520.

In some embodiments, multiply/accumulate units may multiply each left operand element in each row of vector memory 500, aᵢᵣ, with each sequential set of a plurality of (p) right operand elements in vector memory 510, bᵣ₀, . . . , bᵣ₍ₚ₋₁₎, respectively. The multiply/accumulate units may start multiplying the data arrays by multiplying an initial single left operand element, a₀₀, for example, in the first address of vector memory 500 and an initial set of (p) right operand elements, b₀₀, . . . , b₀₍ₚ₋₁₎, for example, in the first (p) addresses, 0x0-0x2(p−1), of vector memory 510. This set of (p) products includes the first terms of the linear combinations for the first (p) elements (the first row) of the product data array. Multiply/accumulate unit(s) may store the set of (p) products 522 in (p) sequential addresses to contribute to the linear combinations of the (p) elements of the product data array. For each sequential (n−1) multiplication operations, multiply/accumulate unit(s) may multiply the next sequential left operand element, for example, in the next sequential address of vector memory 500, with the next sequential set of (p) right operand elements, for example, in the next sequential (p) addresses of vector memory 510. Multiply/accumulate unit(s) may add the next sequential (n−1) set 524-526 each having (p) products to the previously stored or added value(s) in the (p) sequential addresses 0x0-0x2(p−1) of product vector memory 520 to contribute to the linear combinations of the elements in the first row of the product data array. Multiply/accumulate units may use (n) multiplication operations to generate all the (n^{th}) terms for each of the linear combinations of the (p) elements of the first row of the product data array, stored in the first (p) addresses in the product vector memory 520. In some embodiments, a multiplication module or multiplication dedicated instructions may automatically command the processor to issue each of the (n) left operand elements and each of the (n) corresponding vector sets of (p) right operand elements to be multiplied simultaneously, in (n) parallel multiply/accumulate units, for generating a complete row of the product data array in each cycle, although any number of multiply/accumulate units may be used.

Once all the (n) sets of (p) products 522-526 are stored in (p) sequential addresses 0x0-0x2(p−1) of product vector memory 520 to generate the first row of the product data array, the processor may proceed to generate the next sequential row. The processor may continue sequentially to multiply the next (n+1^{th}) left operand element, for example, stored in the next sequential address (0x2n) of vector memory 500, with the first set of (p) right operand elements in the vector memory 510 (for example, since the processor has already cycled through the last sequential row of the right operand data array in vector memory 510). The multiply/accumulate units may multiply each of the next (n) sequential left operand element in vector memory 500 with a sequential set of a plurality of (p) right operand elements in vector memory 510, as described, to generate the next (n) sets of (p) products 528-532 added to form the linear combinations of the (p) elements of the next sequential row of the product data array. The processor may proceed to multiply left operand elements in vector memory 500, in sequence by a corresponding set of right operand elements in vector memory 510, until all (n) sets of products 522-538 are stored and added to generate all elements of the product data array in vector memory 520.

The product data array may be stored in vector memory 520 and may remain in the memory, for example, for further processing (in which case, the product data array may become the right operand data array processed by another left operand data array). In another embodiment, the elements of the product data array may be transferred from vector memory 520, for example, to another memory unit or output device. The output device may be, for example, a display to display an image represented by the product data array or a speaker to play a song or audio file represented by the product data array. The other memory may be another internal or external memory (internal memory unit 14, external memory unit 2, and/or storage unit 4 of FIG. 1) for storing the elements as a one-dimensional vector sequence or alternatively to a multi-dimensional data structure.

Multiplication dedicated instructions that execute the multiplication mechanism described in reference to FIGS. 2-5, may include, for example, vsmpyx{SOP} (Vector Split Multiply) and vsmacx{SOP} (Vector Split Multiply Accumulate). The vector split multiply (vsmpyx) instruction may command a processor to, for each row of the left operand data array, multiply each sequential single element in the row of the left operand data array with each sequential row in the right operand data array, where the left operand element and right operand row are in the same sequential order in their respective row and column, to generate a plurality of sequences of products. Vector split multiply accumulate (vsmacx), in addition to multiplying, may add the resulting product to any previously generated products in the linear combination for the product data array elements in the same row as the elements from the left operand data array and the same column as the elements from the right operand data array. Typically the vector split multiply (vsmpyx) instruction is only used for generating the first terms in each linear combination, for example, when there are no previously generated products with which to add. Although the vector split multiply (vsmpyx) and vector split multiply accumulate (vsmacx) are described as separate instructions, alternatively, a single combined instruction may be used that may automatically add if there are previously generated products in the linear combination for the same product element and may automatically not add (or add to a null or zero element) if there are not.

Vector split multiply (vsmpyx) and vector split multiply accumulate (vsmacx) vsmacx{SOP} instructions may each use the following input parameters:

vixX—vector in X—indicates an address of a first row vector of right operand data array elements (for example, stored at a first address in vector memory 510);
viwW—vector in W—indicates an address of a second row vector of right operand data array elements (for example, stored at a second address in vector memory 510);
vcY—coefficient Y—indicates an address of a first single element of left operand data array (for example, stored at a first address in vector memory 500);
vcV—coefficient V—indicates an address of a second single element of left operand data array (for example, stored at a second address in vector memory 500);
SOP—Split Operation—indicates a first number of sequential terms of vixX (the first right operand vector) to multiply by vcY (the first left operand element) and a second number of sequential terms of viwW (the second right operand vector after vixX) to multiply by vcV (the second left operand element after vcY), where multiply/accumulate unit(s) multiply the first number of the first elements before switching to the second number of the second elements; and
voz0—vector out—indicates a destination address where the resulting product vectors are stored (for example, in vector memory 520). This input parameter may not be needed if the storage destination is pre-determined, automatic, or if an initial address has been established after which the elements are consecutively stored. Other instructions and input parameters may be used.

The split operations allow the multiply/accumulate units to switch between composing any of (n) left operand elements with any of (n) right operand vectors. If there are (n) multiply/accumulate units, were n/4=L and L is a positive integer, the optional values for the SOP switch value may be: (a)op(b−a)op(c−b−a) . . . , where L=a+b+c+ . . . +n. The first value (a) may represent the number of multiplications of complex numbers (having a real and/or imaginary component) using the first left operand element (vcY) and the first right operand vector (vixX); the second value (b-a) may represent the number of complex multiplications using the second left operand element (vcV) and the second right operand vector (viwW); etc. In an example in which (16) multiply/accumulate units are used, optional values for the SOP value may be, (1op1op), (1op2op), (1op3op), (2op1op), (2op2op) or (3op1op).

In one example, to multiply two (2×2) data arrays A and B, a processor may execute the instruction (vsmpyx {2op2op} vib0, via0, vib0, via1) to generate the first row of the (2×2) product data array AB. The multiply/accumulate units may multiply the first (2) sequential terms (2op) of a first input vector (vib0)=(b₀₀, b₀₁) (the first row of the right operand data array) by the first (index=0) input element (via0)=(a₀₀) (the first element of the first row of the left operand data array). This may generate the first terms (a₀₀×b₀₀, a₀₀×b₀₁) of the linear combinations of the two elements (ab₀₀, ab₀₁) in the first row of the product matrix. After the two products are generated, multiply/accumulate units may switch inputs (SOP)=(2op2op) and may multiply the next (2) sequential terms (2op) of the input vector (vib0)=(b₁₀, b₁₁) (the next row of the right operand data array) by a second (index=1) sequential input element (via1)=(a₀₁) (the second element in the first row of the left operand data array). This may generate the second terms (a₀₁×b₁₀, a₀₁×b₁₁) of the linear combinations of the two elements (ab₀₀, ab₀₁) in the first row of the product matrix. The multiply/accumulate units may automatically add the second terms (a₀₁×b₁₀, a₀₁×b₁₁) to the first terms (a₀₀×b₀₀, a₀₀×b₀₁) in the linear combinations for the same respective elements to generate the complete elements of the first row of the (2×2) product data array with elements (ab₀₀=a₀₀×b₀₀+a₀₁×b₁₀, ab₀₁=a₀₀×b₀₁+a₀₁×b₁₁).

After the first row of the product data array is generated, the processor may execute the next instruction (vsmacx {2op2op} vib2, via2, vib2, via3) to generate the second row of the (2×2) product data array AB. The multiply/accumulate units may multiply the first (2) sequential terms (2op) of a second input vector (vib2)=(b₀₀, b₀₁) (the same as the first vector (vib0)) by the third (index=2) input element (via2)=(a₁₀) (the first element of the second row of the left operand data array) to generate the first terms (a₁₀×b₀₀, a₁₀×b₀₁) of the second row of the product matrix. Multiply/accumulate units may then switch inputs to multiply the next (2) sequential terms (2op) of the second input vector (vib2)=(b₁₀, b₁₁) (the next row of the right operand data array) by a fourth (index=3) sequential input element (via3)=(a₁₁) (the second element in the second row of the left operand data array) to generate the second terms (a₁₁×b₁₀, a₁₁×b₁₁) of the second row of the product matrix. The multiply/accumulate units may automatically add the first and second terms to generate the second row of the (2×2) product data array with elements (ab₁₀=a₁₀×b₀₀+a₁₁×b₁₀, ab₁₁=a₁₀×b₀₁+a₁₁×b₁₁).

In another example, to multiply two (3×3) data arrays A and B, a processor may execute the following instruction to generate the first row of the (3×3) product data array AB:

(1) vsmpyx {3op1op} vib0, via0, vib0, via1 (to generate the first terms of the three elements of the first row and the first element of the second row of product AB);
(2) vsmacx {3op1op} vib3, via2, vib3, via3 (to generate the second terms of the three elements of the first row and the first element of the second row of product AB);
(3) vsmacx {3op1op} vib6, via4, vib6, via5 (to generate the third terms of the three elements of the first row and the first element of the second row of product AB);
(4) vsmpyx {2op2op} vib1, via1, vib0, via5 (to generate the first terms of the second and third elements in the second row of product AB and the first terms of the first and second elements of the third row of product AB);
(5) vsmacx {2op2op} vib4, via3, vib3, via1 (to generate the second terms of the second and third elements in the second row of product AB and the second terms of the first and second elements of the third row of product AB);
(6) vsmacx {2op2op} vib7, via8, vib6, via9 (to generate the third terms of the second and third elements in the second row of product AB and the third terms of the first and second elements of the third row of product AB).

Other instructions and input parameters may be used.

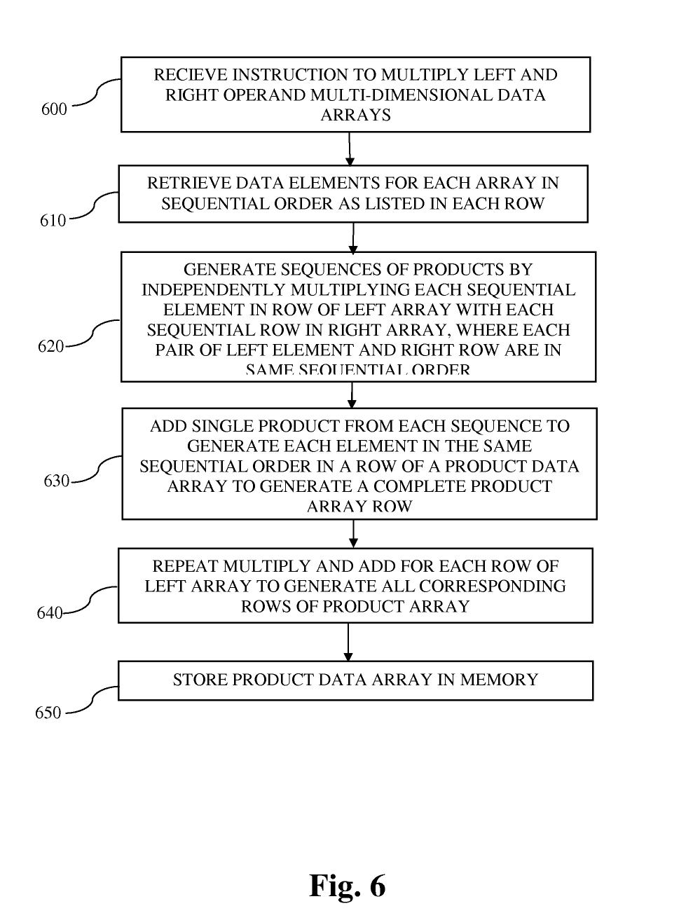

Reference is made to FIG. 6, which is a flowchart of a method for multiplying multi-dimensional data, in accordance with embodiments of the invention.

In operation 600, a processor (for example, processor 1 of FIG. 1) may receive an instruction from a program memory (for example, in external memory 2 or storage unit 4 of FIG. 1) to multiply multi-dimensional data arrays (for example, data arrays 300 and 310 of FIG. 3 or data arrays 400 and 410 of FIG. 4). The instruction may indicate the values or addresses of the data structures to be combined.

The instructions may be multiplication-dedicated instructions configured to implement multiplication schemes according to embodiments of the invention. Alternatively, the instructions may be standard multiplication instructions, where implementations according to embodiments of the invention may be achieved using other instructions, mapping units, or hardware or software modules.

A right operand multi-dimensional data structure may represent values of the multi-dimensional data set, for example, data values of an array or region of pixel(s) in a digital video or image. A left operand multi-dimensional data structure may represent values for editing, filtering or otherwise processing the multi-dimensional data set, for example, applying color, texture, or encoding the pixel data values. Alternatively, either, both or none of the left and right operand data arrays may represent editing filters, image data, or any multi-dimensional data.

In operation 610, the processor may retrieve data elements from a data array in sequential order, for example, as they are sequentially listed in each row, row by row. The processor may store each sequential data element from each data array as a coordinate or element in a vector memory (for example, in vector memories 500 and 510, respectively, of FIG. 5).

In operation 620, the processor (for example, operating multiply/accumulate units 118 of FIG. 1) may independently multiply each data element in a vector memory representing each sequential single element in a row of a left operand data array with a respective vector in a vector memory representing a sequential row in the right operand data array, where the left operand element and right operand row are in the same sequential order, to generate a plurality of vectors or sequences of product elements. The elements of the left operand data array may be used as constants multiplying all elements across a vector or row of elements of the right operand data array.

In operation 630, the processor (for example, operating multiply/accumulate units 118 of FIG. 1) may add a single product element from each of the vectors of product elements to a sum of product elements to generate each respective element in the same sequential order in a row of a product data array to generate a vector representing a complete row of elements of the product data array. The product elements may be added sequentially across a vector representing a row of the product data array that have a right operand element that is from the same column of the right operand data array. Accordingly, the elements of the right operand data array and products containing those elements in the product data array may be vertically aligned. Furthermore, the products multiplied using elements from a row of the left operand data array generate elements in a row of the same index in the product data array. Accordingly, the elements of the left operand data array and products containing those elements in the product data array may be horizontally aligned.

Each pair of vector element representing a sequential left operand element and right operand row in the same order may be multiplied in parallel by one or a plurality of respective multiply accumulate units. In some embodiments, the same number of multiply/accumulate units are used as there are elements in a row of the right operand data array. In this embodiment, all the multiply/accumulate units may together simultaneously multiply all the vector elements represented for an entire row of the left operand data array by vector elements representing their respective rows to generate an entire row of the product row in a single computational cycle. In some embodiments, a multiplication-dedicated instruction (for example, received in operation 600) or dedicated mapping module (for example, map unit 6 of FIG. 1) may automatically issue vector elements representing each pair of left operand element and right operand row to a different one of the plurality of respective multiply/accumulate units.

Operations 620-630 may generate, for example, exactly the products needed to generate a vector representing a single complete row of the product data array.

In operation 640, the processor may repeat operations 620-630 for each row of the left operand data array to generate vectors elements representing all corresponding rows of the product data array until the entire product data array is generated.

In operation 650, the processor may store the vector elements representing the entire product data array in a memory unit. When the product data array represents image or video data, a digital image including a pixel region represented by the product array may be displayed on a monitor or screen (for example, output device 102 of FIG. 1). When the product data array represents audio data, a sound file including portion represented by the product array may be played on a speaker or digital instrument.

Other operations or series of operations may be used.

In some embodiments, each sequential element of the left operand data array may be independently stored at a different individually accessible memory address (for example, in vector memory 500 of FIG. 5), while a plurality of elements in each row of the right operand data array may be all stored together at the same memory address (for example, in vector memory 510 of FIG. 5). In some embodiments, a different coefficient data structure may be used to independently store the elements of the left operand data array and a vector memory may be used to dependently store groups (rows) of elements of the right operand data array using the same address port for all elements in the group.

In one embodiment, the elements of the product array may be generated by executing instructions indicating vector memory addresses of constants (e.g., vcY and vcV of vector memory 500 of FIG. 5) each representing a single element of the left operand data array and vector memory addresses of a first element of vectors each representing a row segment of the right operand data array (e.g., vixX and viwW of vector memory 510 of FIG. 5), and a number of sequential elements of each right operand vector (e.g., Split Operation SOP described in reference to FIG. 5) to be multiplied by each left operand constant before switching to multiply a next pair of a vector and a constant indicated in the next sequential instruction.

Embodiments of the invention may be software-implemented using multiplication-dedicated instruction(s) or, alternatively, hardware-implemented using a multiplication-dedicated mapping module (for example, map unit 6 of FIG. 1) to issue elements of the data arrays in combinations so that the products of data elements in a plurality of sequences generated by multiplying are exactly the products needed to generate a complete row of the product data array.

It may be appreciate that although embodiments of the invention are described to generate one row of the product data array at a time, before proceeding to the next row, other embodiments may also be used. For example, multiply/accumulate units may multiply a single (r^{th}) row of the right operand data array by each element of in a column of the right operand data array of the same (r^{th}) index before proceeding to the next row of the right operand data array. These products may contribute the (r^{th}) term to the linear combinations of elements for the entire product data array. In this example, the data array may be generated as a whole, instead of row by row.

It may be appreciated that although fetch units are described to retrieve values and vector memories are described to store values row-by-row, bursts and registers may alternatively retrieve and store column-by-column. In such embodiments, all elements in each (r^{th}) column of the left operand data array may be multiplied by the single (r^{th}) row of the right operand data array having the same index, (r), before proceeding to the next column of the left operand data array.

It may be appreciated by a person skilled in the art that although embodiments of the invention are described in reference to video or image data that any data having the same or similar digital structure but pertaining to different data types may be used. For example, audio data, graphic data, multimedia data, or any multi-dimensional data may be used.

It may be appreciated by a person skilled in the art that when referring to elements of a data array, embodiments of the invention may these elements may include secondary data, information or pointers representing those elements, e.g., stored as elements in a vector memory structure.

When used herein, the terms data array and matrix may be used interchangeably to indicate a two or more dimensional array of values, which are multiplied according to equation (1). The two or more dimensional array of values may be stored and manipulated in one dimension (as a string of data elements) in vector memory units or in two or more dimensions in other memory units.

It may be appreciated by a person skilled in the art that although embodiments of the invention are described in reference to two dimensional (2D) data arrays, for example, (2×2), (3×3), (m×n), or (n×p), where m, n, and p are positive integers greater than (1), any number, size, and dimension of data arrays, for example, three-dimensional (3D) data arrays, for example, (2×2×2), (3×3×3), (m×n×p), may be used.

Embodiments of the invention may include an article such as a computer or processor readable medium, or a computer or processor storage medium, such as for example a memory, a disk drive, or a USB flash memory, for encoding, including or storing instructions which when executed by a processor or controller (for example, processor 1 of FIG. 1), carry out methods disclosed herein.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

What is claimed is:

1. A method for multiplying data arrays, the method comprising:
independently multiplying each data element in a vector memory representing each sequential single element in a row of a left operand data array with a respective vector in a vector memory representing a sequential row in the right operand data array, where the left operand element and right operand row are in the same sequential order, to generate a plurality of vectors of product elements; and
adding a single product element from each of the vectors of product elements to a sum of product elements to generate each respective element in the same sequential order in a row of a product data array to generate a vector representing a complete row of elements of the product data array.

2. The method of claim 1, wherein multiplying vector elements representing elements in a row of a left operand data array generate vector elements representing elements in a row of the same index of the product data array.

3. The method of claim 1, wherein product elements added to generate an element for a column of the product data array have a right operand element that is from the same column of the right operand data array.

4. The method of claim 1, comprising repeating the steps of independently multiplying and adding for vector elements associated with each row of a left operand data array to generate vector elements representing the elements of each row of the product data array having the same row index.

5. The method of claim 1, wherein each pair of vector elements representing a sequential left operand element and right operand row in the same order are multiplied in parallel by a plurality of respective multiply/accumulate units.

6. The method of claim 5, wherein there are the same number of multiply/accumulate units as there are elements in a row of the right operand data array.

7. The method of claim 5, comprising receiving a multiplication-dedicated instruction that automatically issues each pair of vector elements representing a left operand element and right operand row to a different one of the plurality of respective multiply accumulate units.

8. The method of claim 5, wherein the plurality of vector elements representing the elements in each row of the right operand data array are all stored together at the same vector memory address.

9. The method of claim 1, wherein the products of data elements in the plurality of vectors generated by said multiplication are exactly the product elements added to generate data elements representing a complete row of the product data array.

10. The method of claim 1, wherein the right operand data array elements represent data values for an array of pixels in an image and the left operand data array elements represent data values for editing the pixels values.

11. The method of claim 1, comprising executing instructions indicating vector memory addresses of constants each representing a single element of the left operand data array and vector memory addresses of a first element of vectors each representing a row segment of the right operand data array, and a number of sequential elements of each right operand vector to be multiplied by each left operand constant before switching to multiply a next pair of a vector and a constant indicated in the next sequential instruction.

12. A processor for multiplying data arrays, wherein the processor is configured to:
independently multiply each data element in a vector memory representing each sequential single element in a row of a left operand data array with a respective vector in a vector memory representing a sequential row in the right operand data array, where the left operand element and right operand row are in the same sequential order, to generate a plurality of vectors of product elements; and
add a single product element from each of the plurality of vectors of product elements to a sum of product elements to generate each respective element in the same sequential order in a row of a product data array to generate a vector representing a complete row of elements of the product data array.

13. The processor of claim 12, wherein the processor retrieves a vector representing each row of data elements from an individually addressable vector memory and multiplies the data elements of each vector in the right operand data array together.

14. The processor of claim 12, comprising a multiply/accumulate unit to multiply and add in a single computational cycle.

15. The processor of claim 12, comprising a plurality of processors to multiply vector elements representing each sequential element and row of the data arrays in parallel.

16. The processor of claim 15, wherein the number of processors multiplied in parallel is equal to the number of columns of the left operand data array and the number of rows of the right operand data array.

17. A system for multiplying data arrays, the system comprising:
a vector memory for storing data elements of a first and second data arrays, where each row of the data arrays is independently stored at a different vector memory address;
a processor to independently multiply the first and second data arrays by multiplying each data element in the vector memory representing each sequential single element in a row of the first data array with a respective vector in the vector memory representing a sequential row in the second data array, where the single element from the first data array and the row from the second data array are in the same sequential order, to generate a plurality of vectors of product elements, wherein the processor is to add a single product element from each of the plurality of vectors of product elements to a sum of product elements to generate each respective element in the same sequential order in a row of a product data array to generate a vector representing a complete row of elements of the product data array.

18. The system of claim 17, wherein the processor comprises a multiply/accumulate unit to multiply and add in a single computational cycle.

19. The system of claim 17, comprising a plurality of processors to multiply vector elements representing each sequential element and row of the data arrays in parallel.

20. The system of claim 17, comprising a display, wherein at least one of the first and second data arrays store pixel values for a digital image and the processor multiplies vector memory elements representing the data arrays to edit the digital image, and wherein the display displays the edited digital image.
